(19) United States
(12) Patent Application Publication
(10) Pub. No.: US 2010/0161155 A1
(43) Pub. Date: Jun. 24, 2010

(54) AUTOMATIC FLIGHT CONTROL HELICOPTER

(76) Inventor: Janick Simeray, Argenteuil (FR)

Correspondence Address: BLACK LOWE & GRAHAM, PLLC, 701 FIFTH AVENUE, SUITE 4800, SEATTLE, WA, 98104, US

(21) Appl. No.: 12/522,095

(22) PCT Filed: Jan. 2, 2008
(86) PCT No.: PCT/FR08/00006

§ 371 Date: Jul. 2, 2009

(30) Foreign Application Priority Data
Jan. 2, 2007 (FR) 07000016

(51) Int. Cl. G05D 1/00; B64C 27/10; B64C 13/20; A63H 27/133

(52) U.S. Cl. 701/3

(57) ABSTRACT

The invention relates to an autonomous helicopter for recreational purposes or for a swarm-type surveillance system, characterised in that the helicopter has a complete automatic flight control, and in that the flight thereof is stable and automatic due to a device for the automatic control of the altitude, comprising at least two optical receivers, at least one optical emitter, at least two channels for processing signals of the receivers, and at least two motors controlling at least two propellers, at a speed proportional to the total amount of signals received. Said helicopter avoids obstacles by means of an orientation device controlled by the difference between the signals of the two receivers. It advances at a regular speed by means of a shift of the centre of gravity thereof in front of the axis of the two lifting propellers.

### FIELD OF THE INVENTION

The present invention relates to the concept and realization of a motorized flying machine, which is used as a toy or as a very low cost drone, whose flight is made autonomous thanks to an automatic flight control, and possibly associated with a remote controller.

### BACKGROUND OF THE INVENTION

The state of the art does not display any remote controlled flying toy with autonomous flight.

The dexterity required for the flight, for example a 3 channels remote controlled helicopter excludes its use by children, especially in closed room.

The control of multiple axes of movement and orders relating to the orientation of the helicopter are all obstacles to an ergonomic and intuitive control.

The object of the invention is to achieve a toy or a drone for observation in urban areas, whose flight becomes static and stationary in the absence of remote control.

### SUMMARY OF THE INVENTION

There are all kinds of remote controls for motorized flying machine, using radio or infrared. They emit toward the motorized toy acceleration or direction instructions.

These instructions are executed by the vehicle in function of its own position. The user must take into account this constraint to achieve the toy drive. This constraint is not acceptable for a child. Turn right is intuitive when the vehicle away from the driver when the vehicle was returning to the pilot, the order is reversed.

The state of the art document WO2006/076743A describes a flying toy with 2 counter-rotating fans that keeps the altitude constant thanks to a system for detecting the distance of the ground with an optical and coaxial transmitter and receiver system.

The document US2006/0231677 describes a helicopter with 2 counter-rotating fans, and two propellers guidance.

The combination of these two documents, does not realize the invention.

The document WO2004/027434 describes a helicopter using optical image sensors to adapt the position of the centre of gravity in order to control it automatically.

This document is background art.

The invention aims to solve these constraints, and achieves a flying machine whose flight is autonomous.

Combined with an intuitive remote controller it realizes an ergonomic toy. Combined with sensors and devices for reporting or communication, it makes a drone for surveillance and detection.

### BRIEF DESCRIPTION OF THE DRAWINGS

The figures illustrate the different examples and embodiments of the invention.

FIG. 1 shows a front view of the principle of the helicopter with two independent counter revolving propellers.

FIG. 2 shows a side view of the principle of the helicopter with two independent counter revolving propellers.

FIG. 3 represents a side view of the principle of the helicopter with two counter revolving propellers connected together by gears.

FIG. 4 represents the view from top and side of the principle of the processing of the sensor's signal for the motors control.

FIG. 5 shows the basic layout of electronic principle of this treatment.

### DETAILED DESCRIPTION OF THE PREFERRED EMBODIMENT

Preferably, the flying machine; a helicopter, is stable at fixed altitudes in the absence of order.

Preferably, the helicopter is equipped with a system of compensation for the residual auto-rotation.

Preferably the altitude of the helicopter is stable, by using a slave system that regulates the distance to the ground.

According to the invention the helicopter avoids obstacles through an automatism which directs him in a direction without hindrance.

According to one embodiment, the helicopter is not permanently revolving thanks to a slave system that controls its orientation.

Preferably, the helicopter progresses on a regular basis along its axis, by using a balance that generates a horizontal projection to the front of the lift or the propellers.

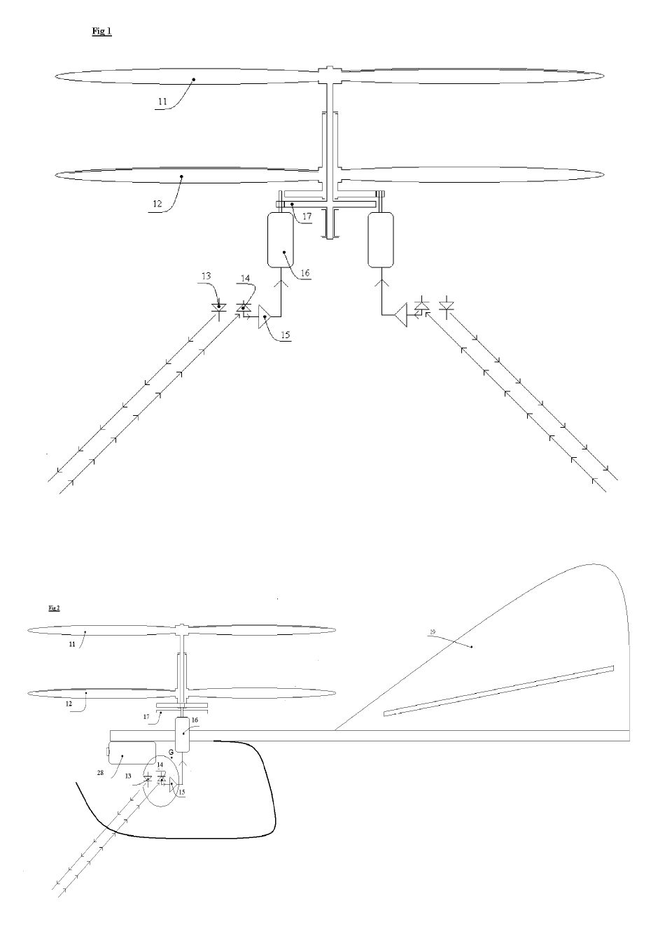

FIG. 1 shows the front view of the helicopter with two counter revolving propellers 11 and 12 each respectively motorized and controlled with an engine 16 and an amplifier device 5, which processes a signal emitted by an optical receiver 14, which signal is proportional to the backscattering of the light emitted to the floor by the emitter 13.

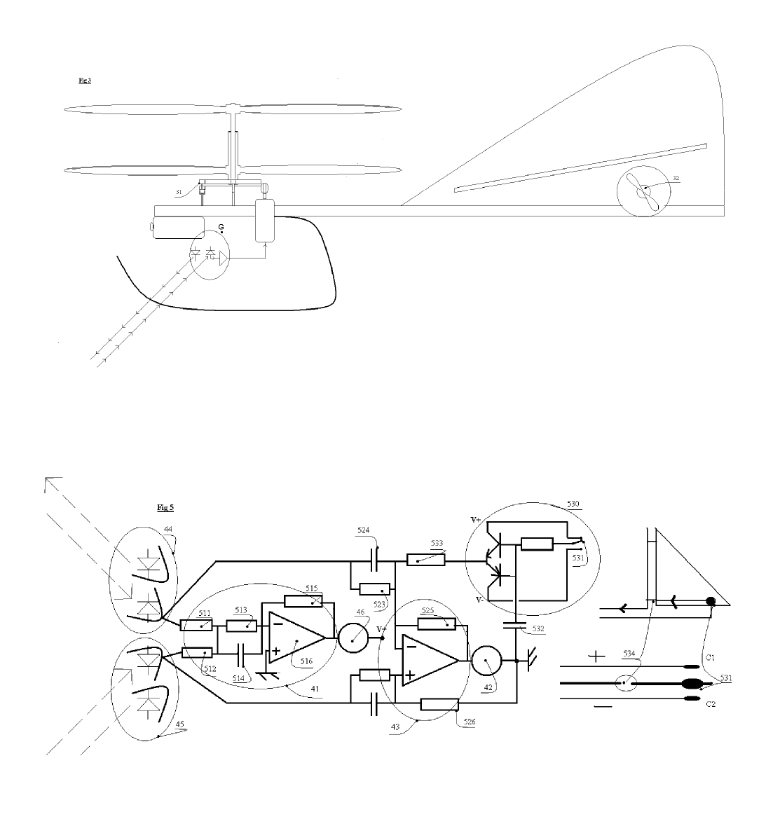

FIG. 2 shows by the same the side the propellers 11 and 22, one motor 16 controlled by a amplifier 55 and a sensor 14 and an emitter 13, and also a batteries 28, which provides autonomous power, and a tail 29 that stabilizes the flight.

Under this embodiment of the invention, the gravity center G is located in the vertical plane of symmetry of the helicopter and slightly offset to the front, so that the lift has a horizontal and front projection.

According to this embodiment of the invention the helicopter includes associated with each propeller 11, 12, a transmitter of light for example an infrared LED 13; an infrared receiver 14, both oriented towards the ground at 45 degrees forward and 45° to the ground.

Preferably the receiver 14 is associated with a filtering system and discriminates the backscattered light from ground and obstacles. This discriminator is for example an optical filter based on wavelength of the optical transmitter or another type of filter, based on a preselected frequency electronic discrimination.

Preferably, the signal proportional to the backscattered light is processed and amplified by an amplifier 15 and then transformed into proportional control of the engine 16, which clutches on a gear 17.

According to the basic principle of the invention, the engine speed is proportional to the sum of the two backscattered light amplitude and its derivative, and also it is fixed at a constant altitude, and it absorbs oscillations altitude.

According to the second principle of the invention, the engine 16 associated with 13, 14 and 15 located at the front right of the helicopter control the propeller 11 rotation in a clockwise direction. By symmetry, the sensors and motors front left side control the rotation of the propeller 12 in the counter-clockwise direction.

Thus, an obstacle detected the right front side for example, results in an increased signal reception, and an acceleration of the propeller 11 that rotates clockwise. In reaction helicopter rotates in the anti-clockwise direction and amend its trajectory to avoid the obstacle.

A wall, a person a drop, and will be perceived as obstacles avoided.

The result for a toy helicopter means ensuring the security of household delicate objects, and also an original remote control mode in which the child would step in the path to change, and follows the helicopter when it is appropriate trajectory.

This results in the military field a swarm of these helicopters will tend to deploy, due to interference between the backscattered beams, and that could swarm deployed where appropriate signal by radio signal and any visual suspected source of heat, such as a sniper.

In this context, the heat detection will be done by sensors according to the state of the art, and the transmission of detection by a radio transmitter, the helicopter detector will be reported by the issuance of flash optical powerful embedded in the helicopter. The helicopter detector will become a marker of a heat source suspicious, like a flashing beacon.

This achieves a primary mode of execution of an autonomous helicopter with flight control.

In a second option achievement, FIG. 3, the helicopter has only one engine at the front 16 for sustenance, but also an engine 32 for guidance and also a gear 31, which reverses the rotation directions of the two propellers, whose rotations are connected.

Preferably, the progression of the helicopter is always associated with the center of gravity shifted forward from the axis of the two propellers. According to the invention, the direction of propagation is controlled by the motorized propeller 32.

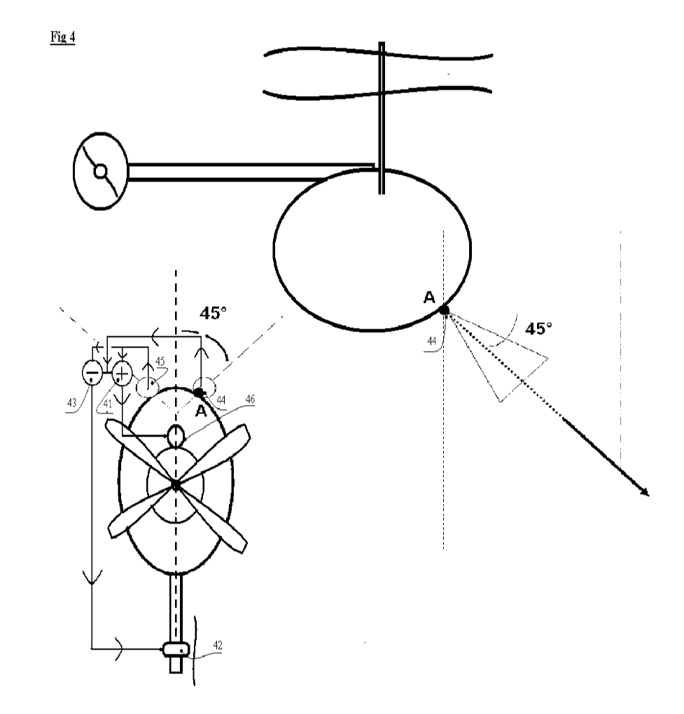

Preferably FIG. 4 represents the helicopter, from top and side view, the signals for obstacle and altitude detection are always issued by an emitter associated with a receiver located front right at 44 and front left 45 respectively, emitting and receiving at the front right and front left, respectively, at 45° laterally and at 45° to the ground.

According to the invention, the control of the sustentation motor 46 is processed by a summing 41, and the engine guidance is processed by 42 a differentiator 43.

According to the invention, the engine 42 turns the helicopter in the counter clockwise direction when the signal 44 is greater than the signal 45.

By this principle, the helicopter behaves exactly as in the previous option.

FIG. 4 gives an overview of the signals processing 44 and 45, with

Adder 41 is realized by an operational amplifier 516, two adder resistor 511 and 512, a differentiator filter 513 and 514 for damping the oscillation altitude and resistance for gain and this controls proportionally the engine 46.

Differentiator 43 controls the engine 42, with two differential filters 524, 523, and two resistors for the gain control 525 and 526.

Finally, the circuit may also include a mechanism for compensating the helicopter's autorotation 530, which acts as an integrator. The helicopter's rotation is detected by the closure of a 3 states switch 531, commanded by the fin tail of helicopter mounted on the pivot 534.

In case of persistent rotation of the helicopter, the closed switch will change the voltage at the terminal of the capacitor 532, which will shift a source of tension in slow variation 530, which delivers an offset voltage to the device 525. This offset voltage has the effect of controlling the engine 42 in order to cancel any residual rotation of the helicopter, and to compensate for all the defects of adjustment in the right and left signal processing chains.

According to another version invention, the helicopter has classical structure, with a single horizontal propeller, and a vertical tail with single propeller opposing the autorotation, the speed of one and the other being bound by a proportional basis.

According to the invention, the speed of the propeller bearer is based on the sum of the amplitudes of the signals retro-reflected by the floor, and the speed of the propeller tail is changed, depending on the difference between the amplitudes of the signals backscattered by the floor.

1. A motorized aircraft providing stable and automatic flight having a slave system that adjusts the altitude and avoids obstacles, comprising:
at least two motors and at least two propellers configured to jointly or independently provide sustenance and guidance for the aircraft; and
means for determining the proximity of the aircraft to the ground or an obstacle according to at least two separate directions by measuring the light backscattered from the ground or the obstacle
comprising at least one optical transmitter, at least one receiver, and at least one channel signal processing receiver;
wherein aircraft altitude is regulated by the control of at least one of the motors at a function of the sum of the levels of the backscattered light according to both directions and the aircraft
avoids obstacles by the control of at least one of the motors for orientation as a function of the difference of the levels of the backscattered light according to both directions.

2. The motorized aircraft according to claim 1, further comprising:
at least one sensor that determines information about the state of the aircraft; and
at least one integrator that receives information about the state of the aircraft from the at least one sensor, wherein the integrator is configured to compensate for the residual rotation that drives the motor to stabilize the aircraft and to provide aircraft guidance based on the sensor information.
